(19) United States
(12) Patent Application Publication
(10) Pub. No.: US 2019/0337279 A1
(43) Pub. Date: Nov. 7, 2019

(54) SPACE-SAVING OPTICAL FUNCTIONAL FILM LAMINATION APPARATUS

(71) Applicant: NITTO DENKO CORPORATION, Ibaraki-shi, Osaka (JP)

(72) Inventors: Naoya SHIMOSONE, Ibaraki-shi, Osaka (JP); Kiyotaka TSUTSUMI, Ibaraki-shi, Osaka (JP); Satoru TAKEDA, Ibaraki-shi, Osaka (JP); Norihiro NAKAMURA, Ibaraki-shi, Osaka (JP); Hiroyuki ABE, Ibaraki-shi, Osaka (JP); Tomohiro HARA, Ibaraki-shi, Osaka (JP); Yoshimitsu SATOU, Ibaraki-shi, Osaka (JP); Kouji AKIYAMA, Ibaraki-shi, Osaka (JP); Kazuo KITADA, Ibaraki-shi, Osaka (JP); Teppei OKUMURA, Ibaraki-shi, Osaka (JP); Hirofumi SAIGOU, Ibaraki-shi, Osaka (JP)

(21) Appl. No.: 16/339,326

(22) PCT Filed: Jul. 7, 2017
(86) PCT No.: PCT/JP2017/025045

§ 371 Date: Apr. 3, 2019

(30) Foreign Application Priority Data
Oct. 4, 2016 (JP) 2016-196458

(51) Int. Cl. B32B 38/18; B32B 37/00; B32B 37/12; B32B 37/18

(52) U.S. Cl. CPC B32B 38/1808; B32B 37/0053; B65H 37/04; B32B 37/182; B32B 2457/20; B32B 37/12

(57) ABSTRACT

The lamination apparatus includes a panel member conveying line for conveying the panel member from an entrance part to an exit part, a first lamination unit provided between the entrance part and the exit part, a second lamination unit provided between the entrance part and the exit part of the panel member conveying line, at the exit part side of the first lamination unit, a first film conveying line for supplying an optical film laminate from a transverse direction with respect to the panel member conveying line between the first lamination unit and the second lamination unit for conveying to the first lamination unit, and a second film conveying line for supplying a second optical film laminate from a transverse direction with respect to the panel member conveying line between the first film supplying unit and the first lamination unit for conveying to the second lamination unit.

### CROSS REFERENCE TO RELATED APPLICATION

This application claims the priority of Japanese Patent Application No. 2016-196458, filed on Oct. 4, 2016, in the JPO (Japanese Patent Office). Further, this application is the National Phase Application of International Application No. PCT/JP2017/025045, filed on Jul. 7, 2017, which designates the United States and was published in Japan. Both of the priority documents are hereby incorporated by reference in their entireties.

### TECHNICAL FIELD

The embodiment relates to manufacturing of an optical display unit, and more specifically, relates to an optical functional film lamination apparatus which can be installed even in a narrow space.

### BACKGROUND ART

In recent years, in a manufacturing site of optical display units, continuous manufacturing apparatus and continuous manufacturing method using Roll-to-Panel method (hereinafter referred as RTP method) are employed. In the RTP method, generally, an optical display unit is continuously manufactured as follows. First, a predetermined optical film laminate is fed from a roll. The optical film laminate is configured as including a carrier film, a pressure-sensitive adhesive layer laminated to one of opposite surfaces of the carrier film, and an optical functional film laminated on the carrier film via the pressure sensitive adhesive layer. The optical functional film may be a single-layered or multi-layered film. On a band of optical film laminate fed from the roll, slit lines in a width-wise direction are continuously formed from the optical functional film side, reaching between the pressure-sensitive adhesive layer and the carrier film to thereby form a sheet of optical functional film between adjacent slit lines.

The sheet of optical functional film continuously formed on the carrier film is peeled with the pressure-sensitive adhesive layer from the carrier film by a peeling means, and sent to a laminating position to be laminated with a panel member. Each of the sheets of optical functional film which has reached to the laminating position is laminated with one of opposite surfaces of a panel member separately conveyed to the laminating position by a laminating means provided in the laminating position. The panel member having the sheet of optical functional film laminated on one of opposite surfaces is generally laminated with another sheet of optical functional film on the other of the opposite surfaces. When laminating on the other of the opposite surfaces, the another sheet of optical functional film peeled with a pressure-sensitive adhesive layer from a carrier film by another peeling means is sent to a laminating position different from the position where the first sheet and the panel member were laminated, and laminated with the other of the opposite surfaces of the panel member.

The laminating means used in the RTP method has an upper side laminating roller and a lower side laminating roller which each of rotating axes generally extends in a direction perpendicular to a conveying direction of the sheet of optical functional film and the panel member. The upper and lower laminating rollers apply pressure in opposing directions with each other from a direction perpendicular to surfaces of the sheet of optical functional film and the panel member at the laminating position, with inversely rotating with each other, to laminate the sheet of optical functional film with the panel member from its front end to its rear end. The sheet of optical functional film and the panel member are conveyed to the laminating position with their deviation of relative positions preliminarily corrected, that is, with their positions preliminarily aligned.

For such RTP method manufacturing apparatus, generally, a linear-type apparatus is often adopted. As an example of the linear-type apparatus, an apparatus as described in Patent Document 1 is suggested, for example. In the linear-type apparatus, a panel member conveying path, a supplying unit for optical functional film which is to be laminated with opposite surfaces of the panel member, an optical functional film conveying path, a slit line forming unit, a lamination unit for the panel member and the optical functional film sheet etc. are arranged linearly.

In addition, in order to make an overall length of apparatus shorter than that of the linear-type apparatus, an apparatus in which a panel member is conveyed on a bent-shaped path has also been suggested. For example, an apparatus as described in Patent Document 2 is an example of such bent-shaped apparatus. In the bent-shaped apparatus, each of sheets of optical functional film is laminated with each of opposite surfaces of the panel member in a bent-shaped path where the panel member is conveyed. The supplying unit of the optical functional film and the slit line forming unit are arranged in a space at a side of the panel member path, and the lamination unit for the panel member and the sheet of optical functional film is positioned on the bent-shaped path.

With respect to a space-saving apparatus, an apparatus described in Patent Document 3 is also suggested. In this apparatus, two optical functional film winding out units are arranged lateral to a conveying mechanism of a panel member in parallel, not at lower portions thereof. In addition, two conveying paths of the optical functional films are arranged at lower portions of conveying path of the panel member, and theses film conveying paths are arranged linearly, which conveying direction runs along a panel conveying direction. According to Patent Document 3, with such apparatus configuration, it is considered as possible to provide a manufacturing system in which overall length and overall height are reduced.

By the way, in a technical field of the optical display unit, in response to a requirement for improvement of productivity and/or improvement of lamination accuracy of the panel and the film etc. becoming severe, more apparatuses of sheet-feeding method which have been adopted before the RTP method apparatuses are being replaced with the RT method apparatuses. In the sheet-feeding method apparatus, the apparatus allows for laminating an optical functional film with a panel member, in which the optical functional film sheet is preliminarily cut in sheets in a facility, and carried into a different facility to be laminated with the panel member. However, when replacing the sheet-feeding method apparatus with the RTP method apparatus, a problem arises that installation space is limited. That is, the above described linear-type and/or bent-shaped RTP apparatuses often require wider installation space than the space where the sheet-feeding method apparatus has been installed, and it is difficult to meet a replacement demand with an apparatus having the same configuration as the apparatus which has been installed as a new equipment. Therefore, an apparatus which can be installed even in a narrow space is required.

### CITATION LIST

Patent Document 1: Japanese Laid-Open Patent Publication JP2012-83690A
Patent Document 2: Chinese Utility Model Publication: CN203919939U
Patent Document 3: Japanese Laid-Open Patent Publication JP2014-130286A

### SUMMARY OF INVENTION

### Technical Problem

The problem to be solved by the embodiment is to realize an apparatus configuration which can be installed even in the narrower space by reducing length and width of the entire apparatus compared to that of the conventional RTP method apparatus.

### Solution to Problem

The problem to be solved by the embodiment can be solved by configuring the lamination apparatus of the optical functional film and the panel member such that each part of two conveying paths of the optical functional films to be laminated with each of opposite surfaces of the panel member are overlapped, being one above the other or in parallel to right and left.

The embodiment provides a lamination apparatus for laminating a sheet of a first optical functional film and a sheet of a second optical functional film respectively with each of opposite surfaces of a panel member. The lamination apparatus includes a panel member conveying line, a first and second lamination units provided in a way of the panel member conveying line, a first film conveying line for supplying and conveying a first optical film laminate in which the first optical functional film to be laminated with one of opposite surfaces of the panel member is laminated, and a second film conveying line for supplying and conveying a second optical film laminate in which the second optical functional film to be laminated with the other of opposite surfaces of the panel member is laminated.

The panel member conveying line has an entrance part of the panel member, and an exit part of the panel member which each of opposite surfaces is laminated with the sheets of the first and second optical functional films respectively, and conveys the panel member from the entrance part to the exit part. The first lamination unit is provided between the entrance part and the exit part of the panel member conveying line, and the second lamination unit is provided between the entrance part and the exit part of the panel member conveying line, at the exit part side of the first lamination unit.

The first film conveying line has a first film supplying unit, a first direction change unit, a first pre-direction-change conveying unit, and a first post-direction-change conveying unit. The first film supplying unit supplies a first optical film laminate from a transverse direction with respect to the panel member conveying line between the first lamination unit and the second lamination unit. The first direction change unit changes a conveying direction of the first optical film laminate supplied from the first film supplying unit toward the first lamination unit. The first pre-direction-change conveying unit conveys the first optical film laminate from the first film supplying unit to the first direction change unit, and the first post-direction-change conveying unit conveys the first optical film laminate from the first direction change unit to the first lamination unit.

The second film conveying line has a second film supplying unit, a second direction change unit, a second pre-direction-change conveying unit, and second post-direction-change conveying unit. The second film supplying unit is arranged in parallel with the first film supplying unit, and supplies a second optical film laminate from a transverse direction with respect to the panel member conveying line between the first film supplying unit and the first lamination unit. The second direction change unit changes a conveying direction of the second optical film laminate supplied from the second film supplying unit toward the second lamination unit. The second pre-direction-change conveying unit conveys the second optical film laminate from the second film supplying unit to the second direction change unit, and the second post-direction-change conveying unit conveys the second optical film laminate from the second direction change unit to the second lamination unit.

The lamination apparatus further includes a first laminating means and a second laminating means. The first laminating means is provided in the first lamination unit, and laminates the sheet of the first optical functional film peeled from the first carrier film with one of opposite surfaces of the panel member conveyed to the first lamination unit. The second laminating means is provided in the second lamination unit, and laminates the sheet of the second optical functional film peeled from the second carrier film with the other of opposite surfaces of the panel member conveyed to the second lamination unit.

In one embodiment, the panel member conveying line may be provided so that the panel member is linearly conveyed from the entrance part to the exit part, and at least the first and second post-direction-change conveying units may respectively be arranged above or below the panel member conveying line. The apparatus of this embodiment can reduce a footprint of the apparatus than that of prior art, and no transverse movement of the panel member exists, and thus, a structure of the panel member conveying line can be made simple.

In one embodiment, the panel member conveying line may include a panel member intermediate conveying unit arranged lateral to a straight line connecting the entrance part and the exit part. The panel member intermediate conveying unit may receive the panel member sent out from the first lamination unit at a side end for sending to the second lamination unit. The apparatus of this embodiment can reduce a footprint of the apparatus than that of prior art, and a part where the panel member conveying line and the film conveying line do not overlap can be provided, and thus, it is possible to increase a degree of freedom in designing the film conveying line in such part.

In one embodiment, the first post-direction-change conveying unit and the second post-direction-change conveying unit may be adjacently arranged in parallel. In this case, the first pre-direction-change conveying unit may be arranged as crossing above or below the second post-direction-change conveying unit, or the second pre-direction-change conveying unit may be arranged as crossing above or below the first post-direction-change conveying unit. In the apparatuses of these embodiments, conveying lines of the optical films after direction is changed do not overlap being one above the other, and thus, it is possible to appropriately select the direction in laminating the optical functional film with the panel member depending on necessity.

### BRIEF DESCRIPTION OF DRAWINGS

FIGS. 1(a) and 1(b) show configurations of a lamination apparatus 1 according to a first embodiment.

FIGS. 2(a) and 2(b) show configurations of a lamination apparatus 2 according to a second embodiment.

FIGS. 3(a) and 3(b) show configurations of a lamination apparatus 3 according to a third embodiment.

FIGS. 4(a) and 4(b) show configurations of a lamination apparatus 4 according to a fourth embodiment.

### DESCRIPTION OF EMBODIMENTS

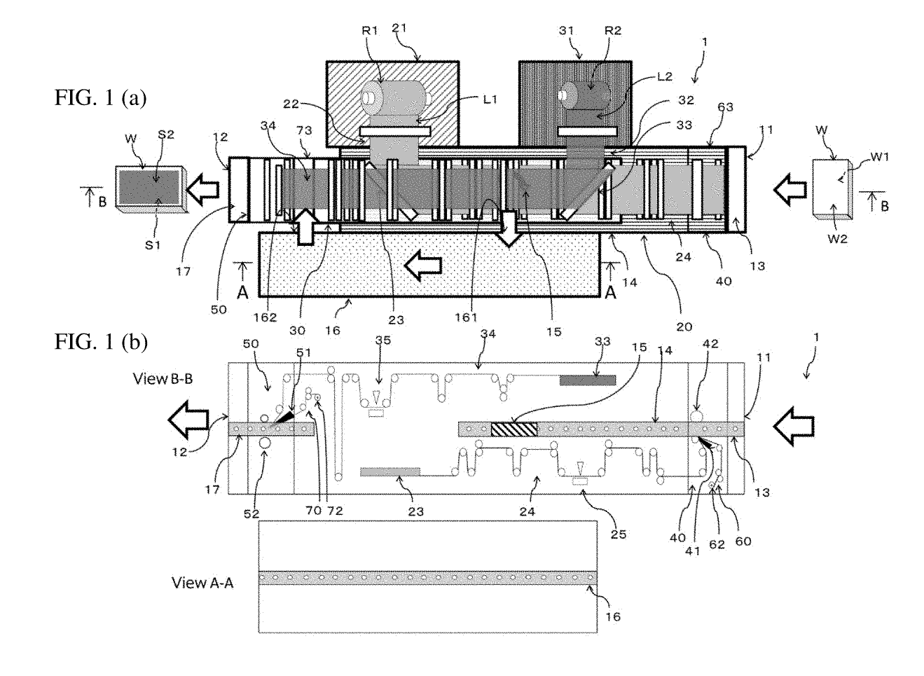

In the following, the embodiments of the present application are described in detail with reference to FIGS. 1(a),1(b), 2(a), 2(b), 3(a), 3(b), 4(a) and 4(b).

### First Embodiment

FIGS. 1(a) and 1(b) show a lamination apparatus 1 according to the first embodiment, wherein FIG. 1 (a) is a plan view, and FIG. 1 (b) is a side view.

The lamination apparatus 1 includes a panel member conveying line 10 for conveying a panel member W, a first lamination unit 40 for laminating one of opposite surfaces W1 of the panel member W (for example, a surface of a thin film transistor (TFT) side) with a sheet S1 of a first optical functional film F1, and a second lamination unit 50 for laminating the other of opposite surfaces W2 of the panel member W (for example, a surface of a color filter (CF) side) with a sheet S2 of a second optical functional film F2. The lamination apparatus 1 further includes a first film conveying line 20 for supplying the first optical functional film F1 to be conveyed to the first lamination unit 40, and a second film conveying line 30 for supplying the second optical functional film F2 to be conveyed to the second lamination unit 50.

### (Conveyance of the Panel Member)

The panel member conveying line 10 for conveying the panel member W has an entrance part 11 where the panel member W enters the lamination apparatus 1 and an exit part 12 where the panel member W exits the lamination apparatus 1. The panel member W is conveyed from the entrance part 11 to the exit part 12, and the first lamination unit 40 and the second lamination unit 50 are provided in a way of the panel member conveying line 10.

When the panel member W enters the lamination apparatus 1 from the entrance part 11, it is conveyed toward the first lamination unit 40 by a panel member conveying unit 13. An orientation of the panel member W when entering from the entrance part 11 is preferably matched with an orientation of the sheet of the first optical functional film F1, and in the lamination apparatus 1, the orientation is such that short sides are parallel to a conveying direction as shown in FIGS. 1(a) and 1(b). It is possible to configure such that the panel member W enters from the entrance part 11 with an orientation different from the orientation of the sheet of the first optical functional film F1 by providing a turning unit in the panel member conveying part 13 which is positioned following the entrance part 11.

In the first lamination unit 40, the sheet S1 of the first optical functional film F1 is laminated with the one of opposite surfaces W1 of the panel member W. The panel member W having the sheet S1 of the first optical functional film F1 laminated therewith exits from the first lamination unit 40, and conveyed by a panel member conveying unit 14.

The panel member W which has exited the first lamination unit 40 is conveyed with the short sides being parallel to the conveying direction, but in the second lamination unit 50 where the other of opposite surfaces W2 of the panel member W is laminated with the sheet S2 of the second optical functional film, lamination with the sheet S2 is done with a short side being a leading end. Therefore, the orientation of the panel member W needs to be turned by 90° at any position from the first lamination unit 40 to the second lamination unit 50. In the lamination apparatus 1, a turning unit 15 is provided after the panel member conveying unit 14 to allow for turning the orientation of the panel member W by 90°.

In the lamination apparatus 1, the panel member W which orientation has been turned by 90°, then moves in a transverse direction to be passed to a panel member conveying unit 16. This panel member conveying unit 16 corresponds to a panel member intermediate conveying unit in claims. The panel member conveying unit 16 is arranged to allow for the panel member W to be conveyed from a position lateral to the turning unit 15 to a position lateral to the second lamination unit 50 in a position lateral to a straight line connecting the entrance part 11 and the exit part 12.

The panel member conveying unit 16 receives the panel member W, which has been turned by 90° in the turning unit 15, at a side end 161. The panel member conveying unit 16 conveys the panel member W to the position lateral to the second lamination unit 50 with long sides being parallel to the conveying direction. The panel member W is passed from a side end 162 of the panel member intermediate conveying unit 16 to the second lamination unit 50 with the orientation just as it is.

In the second lamination unit 50, the sheet S2 of the second optical functional film F2 is laminated with the other of opposite surfaces W2 of the panel member W (that is, the surface with which the sheet S1 of the first optical functional film F1 is not laminated). The panel member W having the sheet S2 of the second optical functional film F2 is laminated therewith exits from the second lamination unit 50, and is conveyed by a panel member conveying unit 17 to exit from the exit part 12.

### (Conveyance of the First Optical Film Laminate)

The first film conveying line 20 conveys a first optical film laminate L1 to the first lamination unit 40. The first optical film laminate L1 is made by laminating a band of the first optical functional film F1 or a sheet S1 of the first optical functional film F1 on a first carrier film C1. When the laminate in which the band of the first optical functional film F1 is laminated on the carrier film C1 is used as the first optical film laminate L1, a first slit line forming unit 25 is provided at any position of the first film conveying line 20.

The first film conveying line 20 has a first film supplying unit 21 for feeding the first optical film laminate L1 from a roll R1 of the first optical film laminate to supply the laminate L1 from a transverse direction with respect to the panel member conveying line 10. The first film supplying unit 21 is arranged lateral to a straight line connecting the entrance part 11 and the exit part 12 of the panel member conveying line 10, and more specifically, lateral to a straight line connecting the first lamination unit 40 and the second lamination unit 50 (that is, between the first lamination unit 40 and the second lamination unit 50). The first film supplying unit 21 includes a supporting means of the roll R1 of the first optical film laminate L1 and a feed roller for feeding the first optical film laminate L1 from the roll R1.

The first optical film laminate L1 fed from the first film supplying unit 21 is conveyed to the first lamination unit 40 via a first pre-direction-change conveying unit 22, a first direction change unit 23, and a first post-direction-change conveying unit 24. The first pre-direction-change conveying unit 22 is preferably provided with dancer rollers for adjusting conveying speed of the optical film laminate L1.

The first direction change unit 23 can change the conveying direction of the optical film laminate L1 conveyed from the transverse direction with respect to the panel member conveying line 10 by the first pre-direction-change conveying unit 22 toward a direction in which the first lamination unit 40 incorporated in the way of the panel member conveying line 10 is arranged. In the lamination apparatus 1, the first direction change unit 23 can turn the direction of the optical film laminate L1 by 90°.

In the lamination apparatus 1, a turn bar can be used as the first direction change unit 23. The turn bar has an outer surface of a cylindrical shape or a semi-cylindrical shape having a length-wise direction corresponding to a width of the first optical film laminate L1, and it is arranged with a predetermined inclined posture with respect to the optical film laminate L1 which direction is to be changed, and when the optical film laminate L1 is wound and hooked around the outer surface, the conveying direction of the optical film laminate L1 which is conveyed along the outer surface can be changed.

In the embodiment, in view of preventing a surface of the optical film laminate L1 from being scratched, an air turn bar is preferably used, which allows for winding and hooking the optical film laminate L1 without being in contact with the outer surface by blowing air from the outer surface to float the optical film laminate L1 with air pressure between the optical film laminate L1 and the outer surface. However, the turn bar is not limited thereto, and an usual turn bar which allows for winding and hooking the optical film laminate L1 being in contact with the outer surface may also be used. The turn bar and the air turn bar have been well-known as techniques for changing directions of a band of a conveying item, and thus, no further details are described here.

The first optical film laminate L1, which conveying direction is changed by 90° by the first direction change unit 23, is conveyed toward the first lamination unit 40 by the first post-direction-change conveying unit 24. The first slit line forming unit 25 provided when the first optical film laminate L1 is the band of the first optical functional film F1 is preferably arranged in the first post-direction-change conveying unit 24. The first post-direction-change conveying unit 24 is preferably provided with the feed roller for sending the first optical film laminate L1 after the direction is changed, and the dancer rollers for adjusting the conveying speed of the optical film laminate L1.

### (Lamination in the First Lamination Unit)

The first optical film laminate L1 is laminated with the one of opposite surfaces W1 of the panel member W in the first lamination unit 40. The first lamination unit 40 is provided between the entrance part 11 and the exit part 12 of the panel member W as shown in FIGS. 1(a) and 1(b).

The first optical film laminate L1 is sent to the first lamination unit 40 after its direction is changed by the first direction change unit 23. The panel member W is sent to the first lamination unit 40 from a direction opposite to the conveying direction of the first optical film laminate L1 across the first lamination unit 40, with the one of opposite surfaces W1 facing downward.

The first lamination unit 40 has a first peeling means 41 for peeling the sheet S1 of the first optical functional film F1 from the first optical film laminate L1. For the first peeling means 41, a wedge-shaped releasing body having a tip end is usually used, but not limited thereto. The sheet S1 of the first optical functional film laminate F1 can gradually be peeled from the first carrier film C1 by winding and hooking the first carrier film C1 around the tip end and folding back in a substantially opposite direction.

The first lamination unit 40 has first laminating rollers 42 for laminating the peeled sheet S1 of the first optical functional film F1 with the one of opposite surfaces W1 of the panel member W. The first laminating rollers 42 have a pair of rollers respectively arranged above and below the conveying path of the panel member W, and by sandwiching the sheet S1 of the first optical functional film F1 and the panel member W from above and below for pressurizing, they can be laminated.

In this embodiment, the first peeling means 41 is provided at a position lower than the panel member conveying line 10, and the sheet S1 of the first optical functional film F1 is laminated from below with the one of opposite surfaces W1 which is facing down. However, the first peeling means 41 may be provided at a position higher than the panel member conveying line 10. In this case, the panel member W is sent to the first lamination unit 40 with the one of opposite surfaces W1 facing upward, and the sheet S1 of the first optical functional film F1 is laminated from above with the one of opposite surfaces W1 which is facing up.

### (Conveyance of the Second Optical Film Laminate)

The second film conveying line 30 conveys a second optical film laminate L2 to the second lamination unit 50. The second optical film laminate L2 is made by laminating a band of the second optical functional film L2 or a sheet S2 of the second optical functional film F2 on a second carrier film C2. When the laminate in which the band of the second optical functional film F2 is laminated on the carrier film C2 is used as the second optical film laminate L2, a second slit line forming unit 35 is provided at any position of the second film conveying line 30.

The second film conveying line 30 has a second film supplying unit 31 for feeding the second optical film laminate L2 from a roll R2 of the second optical film laminate to supply the laminate L2 from the transverse direction with respect to the panel member conveying line 10. The second film supplying unit 31 is arranged lateral to the straight line connecting the entrance part 11 and exit part 12 of the panel member conveying line 10, and more specifically, arranged in parallel with the first film supplying unit 21 (at a same side of the apparatus) between the first film supplying unit 21 and the first lamination unit 40. The second film supplying unit 31 includes a supporting means of the roll R2 of the second optical film laminate L2, and a feed roller for feeding the second optical film laminate L2 from the roll R2.

The second optical film laminate L2 fed from the second film supplying unit 31 is conveyed to the second lamination unit 50 via a second pre-direction-change conveying unit 32, a second direction change unit 33, and a second post-direction-change conveying unit 34. The second pre-direction-change conveying unit 32 is preferably provided with dancer rollers for adjusting conveying speed of the optical film laminate L2.

The second direction change unit 33 can change the conveying direction of the optical film laminate L2 conveyed from the transverse direction with respect to the panel member conveying line 10 by the second pre-direction-change conveying unit 32 toward a direction in which the second lamination unit 50 incorporated in the way of the panel member conveying line 10 is arranged. The direction of the second optical film laminate L2 changed by the second direction change unit 33 is the one opposite to that of the first optical film laminate L1 changed by the first direction change unit 23. In the lamination apparatus 1, the second direction change unit 33 can turn the direction of the optical film laminate L2 by 90°.

Similar to the first direction change unit 23, a turn bar can be used as the second direction change unit 33. The turn bar has an outer surface of a cylindrical shape or a semi-cylindrical shape having a length-wise direction corresponding to a width of the second optical film laminate L2, and it is arranged with a predetermined inclined posture with respect to the optical film laminate L2 which direction is to be changed, and when the optical film laminate L2 is wound and hooked around the outer surface of the turn bar, the conveying direction of the optical film laminate L2 which is conveyed along the outer surface can be changed.

In the embodiment, in view of preventing a surface of the optical film laminate L2 from being scratched, an air turn bar is preferably used, which allows for winding and hooking the optical film laminate L2 without being in contact with the outer surface by blowing air from the outer surface to float the optical film laminate L2 with air pressure between the optical film laminate L2 and the outer surface. However, the turn bar is not limited thereto, and an usual turn bar which allows for winding and hooking the optical film laminate L2 being in contact with the outer surface may also be used. The turn bar and the air turn bar have been well-known as techniques for changing directions of a band of a conveying item, and thus, no further details are described here.

The second optical film laminate L2 which conveying direction is changed by 90° by the second direction change unit 33 is conveyed toward the second lamination unit 50 by the second conveying unit after direction is changed 34. The second slit line forming unit 35 provided when the second optical film laminate L2 is the band of the second optical functional film F2 is preferably arranged in the second post-direction-change conveying unit 34. The second post-direction-change conveying unit 34 is preferably provided with a feed roller for sending the second optical film laminate L2 after the direction is changed, and dancer rollers for adjusting the conveying speed of the optical film laminate L2.

In the lamination apparatus 1, as shown in FIG. 1(b), the second direction change unit 33 is provided at a position higher than a height of the panel member conveying line 10, and the second post-direction-change conveying unit 34 can be provided over and under the height of the panel member conveying line 10. The panel member conveying line 10 is provided with the panel member conveying unit 16 at a position lateral to the straight line connecting the entrance part 11 and the exit part 12, and configured such that the conveying path of the panel member W bends. With such configuration, interference of the panel member conveying line 10 and the second post-direction-change conveying unit 34 can be avoided, and also, a space spanning above and below the panel member conveying line 10 can be utilized, and thus, it is possible to improve a degree of freedom in designing the apparatus.

In addition, in this embodiment, the second direction change unit 33 and the second post-direction-change conveying unit 34 are provided at positions higher than the first direction change unit 23 and the first post-direction-change conveying unit 24, but they also can be provided at positions lower than the first direction change unit 23 and the first post-direction-change conveying unit 24. In such case, the panel member conveying unit 16 is preferably moved from the position shown in FIGS. 1(a) and 1(b) to a position closer to the entrance part 11 so that the first post-direction-change conveying unit 24 and the panel member conveying line 10 do not interfere.

### (Lamination in the Second Lamination Unit)

The second optical film laminate L2 is laminated with the other of opposite surfaces W2 of the panel member W in the second lamination unit 50. The second lamination unit 50 is provided between the first lamination unit 40 and the exit part 12, more specifically, at the exit part 12 side of the first direction change unit 23, as shown in FIGS. 1(a) and 1(b).

The second optical film laminate L2 is sent to the second lamination unit 50 after its direction is changed by the second direction change unit 33. The panel member W is sent to the second lamination unit 50 from a position lateral to the second lamination unit 50 with the other of opposite surfaces W2 facing upward. The panel member conveying unit 16 may be made shorter than the one shown in FIGS. 1(a) and 1(b) to send the panel member W to the second lamination unit 50 after once returning it to the path on the straight line connecting the entrance part 11 and the exit part 12.

The second lamination unit 50 has a second peeling means 51 for peeling the sheet S2 of the second functional film F2 from the second optical film laminate L2. For the second peeling means 51, a wedge-shaped releasing body having a tip end is usually used, but not limited thereto. The sheet S2 of the second optical functional film laminate F2 can gradually be peeled from the second carrier film C2 by winding and hooking the second carrier film C2 around the tip end and folding back in a substantially opposite direction.

The second lamination unit 50 has second laminating rollers 52 for laminating the peeled sheet S2 of the second optical functional film F2 with the other of opposite surfaces W2 of the panel member W. The second laminating rollers 52 have a pair of rollers respectively arranged above and below the conveying path of the panel member W, and by sandwiching the sheet S2 of the second optical functional film F2 and the panel member W from above and below for pressurizing, they can be laminated.

In this embodiment, the second peeling means 51 is provided at a position higher than the panel member conveying line 10, and the sheet S2 of the second optical functional film F2 is laminated from above with the other of opposite surfaces W2 which is facing up. However, when the first peeling means 41 is provided at a position higher than the panel member conveying line 10, the second peeling means 51 is preferably provided at a position lower than the panel member conveying line 10. In this case, the panel member W is sent to the second lamination unit 50 with the other of opposite surfaces W2 facing downward, and the sheet S2 of the second optical functional film F2 is laminated from below with the other of opposite surfaces W2 which is facing down.

### (Ejection at an Ejection Unit)

the first lamination unit 40, the first carrier film C1 after the sheet S1 of the first optical functional film F1 is peeled is conveyed to a first ejection unit 60. The first ejection unit 60 may preferably have a feed roller, a first winding means 62 for winding the first carrier film C1, and a first ejection port 63 for ejecting a wound roll of the first carrier film C1.

Similarly, in the second lamination unit 50, the second carrier film C2 after the sheet S2 of the second optical functional film F2 is peeled is conveyed to a second ejection unit 70. The second ejection unit 70 may preferably have a feed roller, a second winding means 72 for winding the second carrier film C2, and a second ejection port 73 for ejecting a wound roll of the second carrier film C2.

The first ejection port 63 and the second ejection port 73 are preferably provided toward a direction same as the one which the first film supplying unit 21 and the second film supplying unit 31 are arranged in the lamination apparatus 1. By providing the ejection ports 63 and 73 of the carrier film after being peeled in such direction, it is possible to perform a roll removing operation of the first carrier film C1 after being peeled in a space adjacent to the second film supplying unit 31 and the first lamination 40, and a roll removing operation of the second carrier film C2 after being peeled in a space adjacent to the first film supplying unit 21 and the second lamination unit 50. By using these spaces which may become dead spaces as spaces for processing ejected rolls, the space required for arranging the lamination apparatus 1 can be made narrower.

### Second Embodiment

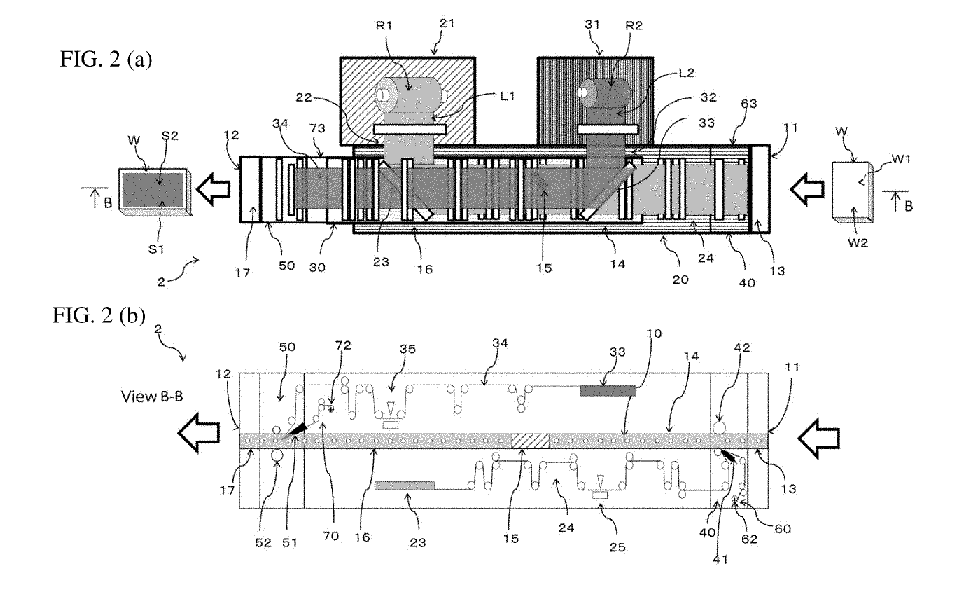

FIGS. 2(a) and 2(b) show a lamination apparatus 2 according to the second embodiment, wherein FIG. 2 (a) is a plan view, and FIG. 2 (b) is a side view. In FIGS. 2(a) and 2(b), elements which are the same as ones in FIGS. 1(a) and 1(b) are described with the same reference numerals. In addition, elements and configurations which are not described here are the same as in FIGS. 1(a) and 1(b). The lamination apparatus 2 according to the second embodiment is different from the lamination apparatus 1 according to the first embodiment in a shape of the panel member conveying line 10, and a positional relationship of the panel member conveying line 10 and the film conveying lines 20 and 30.

In the lamination apparatus 2, the panel member conveying line 10 is provided such that the panel member W is conveyed linearly from the entrance part 11 to the exit part 12. That is, the panel member W entered into the lamination apparatus 2 from the entrance part 11 is conveyed to the first lamination unit 40 by the panel conveying unit 13. The panel member W having the sheet S1 of the first optical functional film F1 laminated on the one of opposite surfaces W1 in the first lamination unit 40 exits the first lamination unit 40, and is conveyed to the turning unit 15 by the panel member conveying unit 14.

The panel member W which has been turned by 90° in the turning unit 15 is linearly passed as it is to the panel member conveying unit 16. In the lamination apparatus 1 according to the first embodiment, the panel member conveying unit 16 is arranged lateral to the straight line connecting the entrance part 11 and the exit part 12, but in the lamination apparatus 2 according to the present embodiment, it is configured to linearly connect the turning unit 15 and the second lamination unit 50. Therefore, the panel member W is linearly conveyed to the second lamination unit 50 by the panel member conveying unit 16.

The panel member W having the sheet S2 of the second optical functional film F2 laminated on the other of opposite surfaces W2 in the second lamination unit 50 exits from the second lamination unit 50, conveyed by the panel member conveying unit 17, and exits from the exit part 12.

In the lamination apparatus 2, along with the panel member W being conveyed linearly from the entrance part 11 to the exit part 12, a positional relationship between the panel member conveying line 10, the first film conveying line 20, and the second film conveying line 30 is different from that of the lamination apparatus 1 in the embodiment 1. That is, in a case of the lamination apparatus 2, as shown in FIG. 2 (b), the first direction change unit 23 and the first post-direction-change conveying unit 24 of the first film conveying line 20 are arranged below the panel conveying units 14 and 16 and the turning unit 15 of the panel conveying line 10, and the second direction change unit 33 and the second post-direction-change conveying unit 34 of the second film conveying line 30 are arranged above the panel conveying units 14 and 16 and the turning unit 15 of the panel conveying line 10.

As another embodiment, contrary to the arrangement shown in FIG. 2 (b), the first direction change unit 23 and the first post-direction-change conveying unit 24 of the first film conveying line 20 may be arranged above the panel conveying units 14 and 16 and the turning unit 15 of the panel conveying line 10, and the second direction change unit 33 and the second post-direction-change conveying unit 34 of the second film conveying line 30 may be arranged below the panel conveying units 14 and 16 and the turning unit 15 of the panel conveying line 10.

The lamination apparatus 2 allows for narrowing a width of the apparatus compared with the lamination apparatus 1 by configuring the positional relationship of the panel member conveying line 10 and the first and second film conveying lines 20 and 30 as being overlapped one above the other as described in the above, and thus, it is possible to have a less footprint for the apparatus. In addition, since the panel member W does not move transversely, a structure of the panel member conveying line 10 can be made simple.

### Third Embodiment

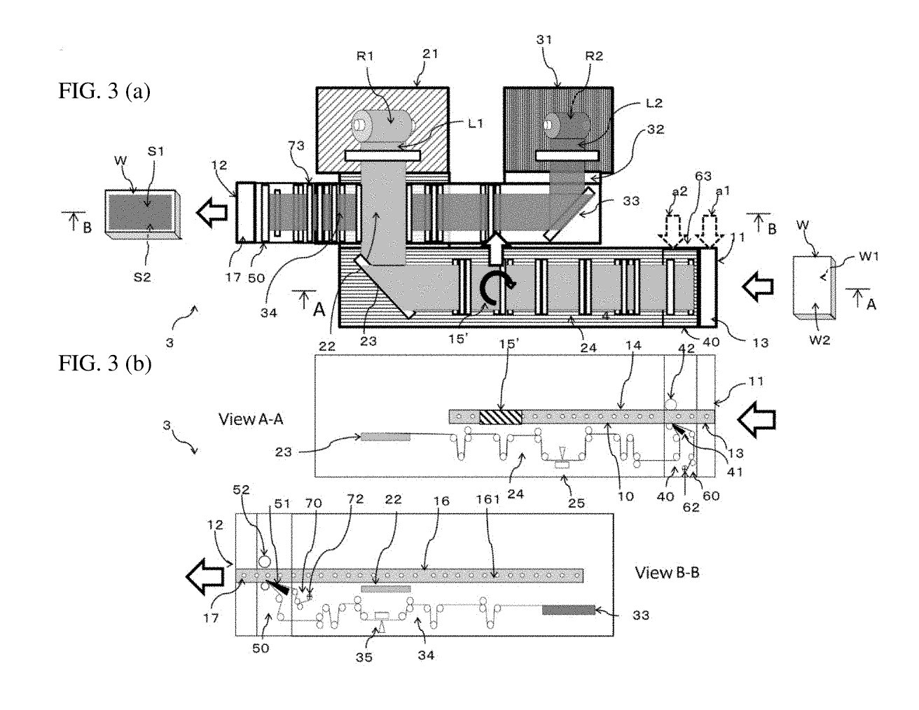

FIGS. 3(a) and 3(b) show a lamination apparatus 3 according to the third embodiment, wherein FIG. 3 (a) is a plan view, and FIG. 3 (b) is a side view. In FIGS. 3(a) and 3(b), elements which are the same as ones in FIGS. 1(a) and 1(b) are described with the same reference numerals. In addition, elements and configurations which are not described here are the same as in FIGS. 1(a) and 1(b). The lamination apparatus 3 according to the third embodiment is different from the lamination apparatus 1 according to the first embodiment in the positional relationship between the first film conveying line 20 and the second film conveying line 30, and a shape of the panel member conveying line 10 which is configured responding thereto.

In the lamination apparatus 3, different from the lamination apparatus 1 according to the first embodiment and the lamination apparatus 2 according to the second embodiment, a part of the first film conveying line 20 and a part of the second film conveying line 30 are arranged adjacently in parallel in a planar view. Specifically, in the lamination apparatus 3, the second direction change unit 33 and the second post-direction-change conveying unit 34 in the second film conveying line 30 are arranged adjacently in parallel with the first direction change unit 23 and the first post-direction-change conveying unit 24 between the first direction change unit 23 and the first post-direction-change conveying unit 24 in the first film conveying line 20, and first and second film supplying units 21 and 31, in a planar view.

More specifically, the first optical film laminate L1 supplied from the first film supplying unit 21 is conveyed to the first direction change unit 23 by the first pre-direction-change conveying unit 22, but in the lamination apparatus 3, this first pre-direction-change conveying unit 22 is arranged as crossing above the second post-direction-change conveying unit 34. The first optical film laminate L1 conveyed as crossing above the second post-direction-change conveying unit 34 is turned by 90° of its direction by the first direction change unit 23, and then, conveyed to the first lamination unit 40 by the first post-direction-change conveying unit 24.

On the other hand, the second optical film laminate L2 is, after supplied from the second film supplying unit 31, turned by 90° of its direction by the second direction change unit 33, and then conveyed to the second lamination unit 50 by the second post-direction-change conveying unit 34 arranged adjacent to the first post-direction-change conveying unit 24 in parallel (at a side where the first and second film supplying units 21 and 31 are arranged) in a planar view.

In the lamination apparatus 3, responding to the relationship of the first film conveying line 20 and the second film conveying line 30, the panel member conveying line 10 is configured as being a bent path. More specifically, the panel member W which has entered from the entrance part 11 is, after laminated with the sheet S1 of the first optical functional film F1 in the first lamination unit 40, conveyed to an turning and flipping-over unit 15′ by the film conveying unit 14 provided above the first post-direction-change conveying unit 24.

The panel member W is, after turned by 90° and its upper and lower surfaces flipped over in the turning and flipping-over unit 15′, moved in a transverse direction (in a direction of the first and second film supplying units 21 and 31) from a side end 141 of the panel member conveying unit 14, and then passed to the panel member conveying unit 16 provided above the second post-direction-change conveying unit 34. The panel member W is conveyed above the second post-direction-change conveying unit 34 to the second lamination unit 50 by the panel member conveying unit 16.

In FIGS. 3(a) and 3(b), the first pre-direction-change conveying unit 22 is arranged as crossing above the second post-direction-change conveying unit 34, but the first pre-direction-change conveying unit 22 may be arranged as crossing below the second post-direction-change conveying unit 34.

In addition, in this embodiment, it is configured such that the sheet of the optical functional film is laminated with the panel member W from below in either of the first lamination unit 40 and the second lamination 50, but it is not limited to such configuration. For example, the second post-direction-change conveying unit 34 may be arranged above the panel member conveying unit 16 in a side view to laminate the sheet S2 of the second optical functional film F2 with the other of opposite surfaces W of the panel member W from above in the second lamination unit 50. In this case, the turning unit 15 is provided instead of the turning and flipping-over unit 15′.

As one embodiment, in the lamination apparatus 3, the entrance part 11 of the panel member W may be provided at the side where the first and second film supplying units 21 and 31 are arranged to supply the panel member W to the panel member conveying unit 13 from a lateral position as shown in a dotted-line arrow a1. In this case, the panel member W is sent to the first lamination unit 40 by the panel member conveying unit 13 from a direction perpendicular to a direction which rotating axes of the first laminating rollers 42 extends.

In addition, as one embodiment, in the lamination apparatus 3, the entrance part 11 of the panel member W may be provided at the side where the first and second film supplying units 21 and 31 are arranged to directly supply the panel member W to the first lamination unit 40 from a lateral position as shown in a dotted-line arrow a2. In this case, the panel member W is sent to the first lamination unit 40 from a direction in parallel with the direction which the rotating axes of the first laminating rollers 42 extend, and a predetermined range at a tip end of the panel member W may be arranged between the first laminating rollers 42. The lamination apparatus according to this embodiment allows for further shortening the overall length of the lamination apparatus 1 compared with the configuration where the panel member W is moved from the direction perpendicular to the rotating axes of the first laminating rollers 42.

### Fourth Embodiment

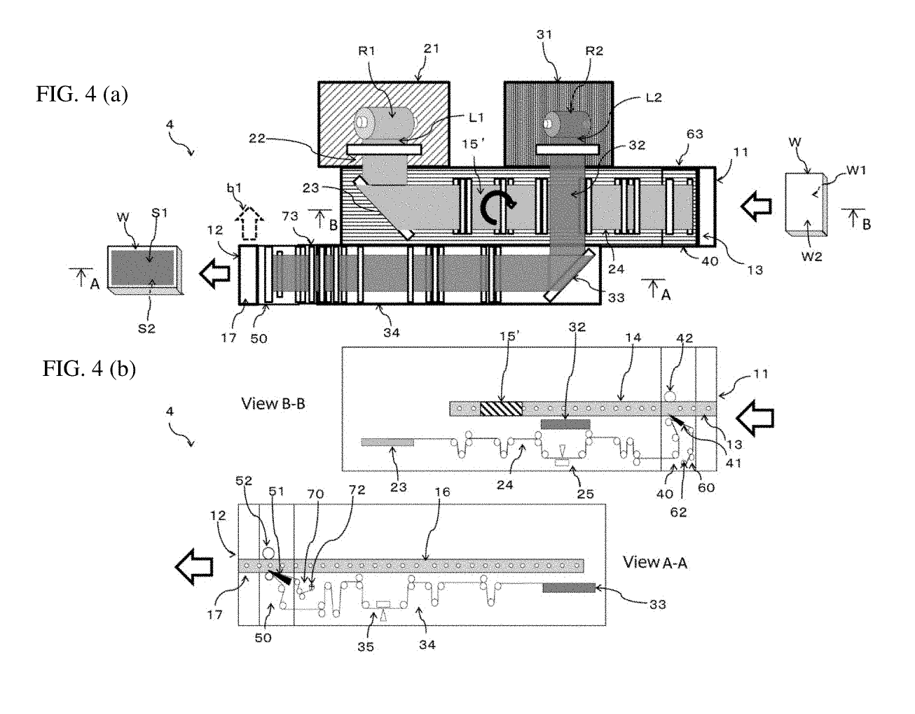

FIGS. 4(a) and 4(b) show a lamination apparatus 4 according to the fourth embodiment, wherein FIG. 4 (a) is a plan view, and FIG. 4 (b) is a side view. The form of the lamination apparatus 4 according to the fourth embodiment is similar to that of the lamination apparatus 3 according to the third embodiment, but it is different from the lamination apparatus 3 in that positions of the first direction change unit 23 and the first post-direction-change conveying unit 24 and positions of the second direction change unit 33 and the second post-direction-change conveying unit 34 are oppositely arranged in a planar view. In FIGS. 4(a) and 4(b), elements which are the same as ones in FIGS. 3(a) and 3(b) are described with the same reference numerals. In addition, elements and configurations which are not described here are the same as in FIGS. 3(a) and 3(b).

In the lamination apparatus 4, the first direction change unit 23 and the first post-direction-change conveying unit 24 in the first film conveying line 20 are arranged adjacently in parallel with the second direction change unit 33 and the second post-direction-change conveying unit 34 between the second direction change unit 33 and the second post-direction-change conveying unit 34 in the second film conveying line 30, and the first and second film supplying units 21 and 31 in a planar view.

More specifically, the second optical film laminate L2 supplied from the second film supplying unit 31 is conveyed to the second direction change unit 33 by the second pre-direction-change conveying unit 32, but in the lamination apparatus 4, this second pre-direction-change conveying unit 32 is arranged as crossing above the first post-direction-change conveying unit 24. The second optical film laminate L2 conveyed as crossing above the first post-direction-change conveying unit 24 is turned by 90° of its direction by the second direction change unit 33, and then, conveyed to the second lamination unit 50 by the second post-direction-change conveying unit 34.

On the other hand, the first optical film laminate L1 is, after supplied from the first film supplying unit 21, turned by 90° of its direction by the first direction change unit 23, and then conveyed to the first lamination unit 40 by the first post-direction-change conveying unit 24 arranged adjacent to the second post-direction-change conveying unit 34 in parallel (at the side where the first and second film supplying units 21 and 31 are arranged) in a planar view.

In the lamination apparatus 4, responding to the relationship of the first film conveying line 20 and the second film conveying line 30, the panel member conveying line 10 is configured as being a bent path. More specifically, the panel member W which has entered from the entrance part 11 is, after laminated with the sheet S1 of the first optical functional film F1 in the first lamination unit 40, conveyed to an turning and flipping-over unit 15′ by the film conveying unit 14 provided above the first post-direction-change conveying unit 24.

The panel member W is, after turned by 90° and its upper and lower surfaces overturned at the turning and flipping-over unit 15′, moved in a transverse direction (in a direction moving farther from the first and second film supplying units 21 and 31) from a side end 141 of the panel member conveying unit 14, and then passed to the panel member conveying unit 16 provided above the second post-direction-change conveying unit 34. The panel member W is conveyed above the second post-direction-change conveying unit 34 to the second lamination unit 50 by the panel member conveying unit 16.

In FIGS. 4(a) and 4(b), the second pre-direction-change conveying unit 32 is arranged as crossing above the first post-direction-change conveying unit 24, but the second pre-direction-change conveying unit 32 may be arranged as crossing below the first post-direction-change conveying unit 24.

In addition, in this embodiment, it is configured such that the sheet of the optical functional film is laminated with the panel member W from below in either of the first lamination unit 40 and the second lamination 50, but it is not limited to such configuration. For example, the first post-direction-change conveying unit 24 may be arranged above the panel member conveying unit 14 and the turning and flipping-over unit 15′ to laminate the sheet S1 of the first optical functional film F1 with one of opposite surfaces W of the panel member W from above in the first lamination unit 40. In this case, the turning and flipping-over unit 15′ is provided instead of the turning unit 15.

As one embodiment, in the lamination apparatus 4, the exit part 12 of the panel member W may be provided at the side where the first and second film supplying units 21 and 31 are arranged to eject the panel member W from the panel member conveying unit 17 to a lateral position, as shown in a dotted-line arrow b1.

The lamination apparatus 3 in the embodiment 3 and the lamination apparatus 4 in the embodiment 4 are of configurations in which the film conveying units after direction is changed do not overlap being one above the other as described in the above, and thus, it is easy to appropriately select the direction for laminating the optical functional film sheet with the panel member W. In addition, compared with the lamination apparatus 2 in the embodiment 2, the overall height of the apparatus can be made lower.

### REFERENCE SIGNS LIST

W: Panel member
W1: One of opposite surfaces
W2: The other of opposite surfaces
L1: first optical film laminate
   C1: First carrier film
   F1: First optical functional film
   S1: Sheet of first optical functional film
L2: Second optical film laminate
   C2: Second carrier film
   F2: Second optical functional film
   S2: Sheet of second optical functional film
R1: Roll of first optical film laminate
R2: Roll of second optical film laminate
1, 2, 3, 4: Lamination apparatus
10: Panel member conveying line
   11: Entrance part
   12: Exit part
   13, 14, 16, 17: Panel member conveying unit
   15: Turning unit
   15′: Turning and flipping-over unit
   141, 161, 162: Side end for panel delivery
20: First film conveying line
   21: First film supplying unit
   22: First pre-direction-change conveying unit
   23: First direction change unit
   24: First post-direction-change conveying unit
   25: First slit line forming unit
30: Second film conveying line
   31: Second film supplying unit
   32: Second pre-direction-change conveying unit
   33: Second direction change unit
   34: Second post-direction-change conveying unit
   35: Second slit line forming unit
40: First lamination unit
   41: First peeling means
   42: First laminating roller
50: Second lamination unit
   51: Second peeling means
   52: Second laminating roller
60: First ejection unit
   62: First winding means
   63: First ejection port
70: Second ejection unit
   72: Second winding means
   73: Second ejection port

1. A lamination apparatus for laminating a sheet of a first optical functional film and a sheet of a second optical functional film respectively with each of opposite surfaces of a panel member, comprising:
a panel member conveying line, having an entrance part of the panel member, and an exit part of the panel member which each of opposite surfaces is laminated with the sheets of the first and second optical functional films respectively for conveying the panel member from the entrance part to the exit part;
a first lamination unit provided between the entrance part and the exit part of the panel member conveying line;
a second lamination unit provided between the entrance part and the exit part of the panel member conveying line, at the exit part side of the first lamination unit;
a first film conveying line having a first film supplying unit for supplying a first optical film laminate in which the first optical functional film is laminated on a first carrier film from a transverse direction with respect to the panel member conveying line between the first lamination unit and the second lamination unit, a first direction change unit for changing a conveying direction of the first optical film laminate supplied from the first film supplying unit toward the first lamination unit, a first pre-direction-change conveying unit for conveying the first optical film laminate from the first film supplying unit to the first direction change unit, and a first post-direction-change conveying unit for conveying the first optical film laminate from the first direction change unit to the first lamination unit;
a second film conveying line having a second film supplying unit arranged in parallel with the first film supplying unit for supplying a second optical film laminate in which the second optical functional film is laminated on a second carrier film from a transverse direction with respect to the panel member conveying line between the first film supplying unit and the first lamination unit, a second direction change unit for changing a conveying direction of the second optical film laminate supplied from the second film supplying unit toward the second lamination unit, a second pre-direction-change conveying unit for conveying the second optical film laminate from the second film supplying unit to the second direction change unit, and a second post-direction-change conveying unit for conveying the second optical film laminate from the second direction change unit to the second lamination unit;
a first laminating means provided in the first lamination unit for laminating the sheet of the first optical functional film peeled from the first carrier film with one of opposite surfaces of the panel member conveyed to the first lamination unit, and
a second laminating means provided in the second lamination unit for laminating the sheet of the second optical functional film peeled from the second carrier film with the other of opposite surfaces of the panel member conveyed to the second lamination unit.

2. The lamination apparatus according to claim 1, wherein the panel member conveying line is provided so that the panel member is linearly conveyed from the entrance part to the exit part, and at least the first and second post-direction-change conveying units are respectively arranged above or below the panel member conveying line.

3. The lamination apparatus according to claim 1, wherein the panel member conveying line includes a panel member intermediate conveying unit arranged lateral to a straight line connecting the entrance part and the exit part, wherein the panel member intermediate conveying unit receives the panel member sent out from the first lamination unit at a side end for sending to the second lamination unit.

4. The lamination apparatus according to claim 1, wherein the first post-direction-change conveying unit and the second post-direction-change conveying unit are adjacently arranged in parallel.

5. The lamination apparatus according to claim 4, wherein the first pre-direction-change conveying unit is arranged as crossing above or below the second post-direction-change conveying unit.

6. The lamination apparatus according to claim 5, wherein the panel member is supplied to the first lamination unit from a transverse direction of the first lamination unit.

7. The lamination apparatus according to claim 4, wherein the second pre-direction-change conveying unit is arranged as crossing above or below the first post-direction-change conveying unit.

8. The lamination apparatus according to claim 1, wherein the panel member conveying line further includes a turning unit for turning the panel member by 90° sent out from the first lamination unit.

9. The lamination apparatus according to claim 1, wherein the first film conveying line has a first slit line forming unit for forming slit lines in the first optical film laminate to continuously form the sheet of the first optical functional film on the first carrier film.

10. The lamination apparatus according to claim 1, wherein the second film conveying line has a second slit line forming unit for forming slit lines in the second optical film laminate to continuously form the sheet of the second optical functional film on the second carrier film.

11. The lamination apparatus according to claim 1, further including a first winding means for winding the first carrier film after the first optical functional film is peeled in the first lamination unit, and a second winding means for winding the second carrier film after the second optical functional film is peeled in the second lamination unit,
wherein a first ejection port for ejecting a roll of the first carrier film wound in the first winding means and a second ejection port for ejecting a roll of the second carrier film wound in the second winding means are both provided toward a direction same as the one which the first film supplying unit and the second film supplying unit are arranged.
